(19) United States
(12) Patent Application Publication
(10) Pub. No.: US 2017/0312694 A1
(43) Pub. Date: Nov. 2, 2017

(54) FILTRATION MODULE AND FILTRATION APPARATUS

(71) Applicant: SUMITOMO ELECTRIC INDUSTRIES, LTD., Osaka-shi, Osaka (JP)

(72) Inventors: Hiromu TANAKA, Osaka (JP); Tomoyuki YONEDA, Osaka (JP); Toru MORITA, Osaka (JP)

(73) Assignee: SUMITOMO ELECTRIC INDUSTRIES, LTD., Osaka-shi, Osaka (JP)

(21) Appl. No.: 15/523,715

(22) PCT Filed: Nov. 20, 2015
(86) PCT No.: PCT/JP2015/082693

§ 371 Date: May 2, 2017

(30) Foreign Application Priority Data
Dec. 4, 2014 (JP) 2014-245868

(51) Int. Cl. B01D 65/02; B01D 63/02; B01D 69/08; B01D 71/36

(52) U.S. Cl. CPC B01D 65/02; B01D 71/36; B01D 63/02; B01D 69/081; B01D 2321/18

(57) ABSTRACT

A filtration module according to one embodiment of the present invention includes plural hollow fiber membranes held while being aligned in one direction and a pair of holding members that fix both ends of the hollow fiber membranes. In the holding members, an existence region where the hollow fiber membranes exist has a rectangular shape in a direction perpendicular to the direction in which the hollow fiber membranes are aligned. The hollow fiber membranes are arranged in a matrix in a long side direction and a short side direction of the existence region. In the existence region, a ratio of an average pitch of the hollow fiber membranes in the long side direction to an average pitch of the hollow fiber membranes in the short side direction is 1.2 or more and 2.5 or less.

### TECHNICAL FIELD

The present invention relates to a filtration module and a filtration apparatus.

### BACKGROUND ART

Filtration apparatuses equipped with filtration modules that include bundles of hollow fiber membranes have been used as solid liquid separation treatment apparatuses in wastewater treatment, processes of producing medicines, and the like. Examples of the filtration modules include external pressure modules in which the pressure on the outer circumferential side of the hollow fiber membranes is increased so that the liquid to be treated will penetrate into the inner circumferential side of the hollow fiber membranes, immersion type modules in which the liquid to be treated is caused to permeate into the inner circumferential side by osmotic pressure or by decreasing the pressure at the inner circumferential side, and internal pressure modules in which the pressure at the inner circumferential side of the hollow fiber membranes is increased so that the liquid to be treated will permeate toward the outer circumferential side of the hollow fiber membranes.

Among the filtration modules described above, external pressure filtration modules and immersion type filtration modules become contaminated as substances contained in the liquid to be treated adhere to the surfaces of the hollow fiber membranes due to operation, and their filtration ability will be degraded if left contaminated. To address this issue, a cleaning method (air scrubbing) has been employed with which air bubbles are supplied from below the filtration modules so that the air bubbles abrade the surfaces of the hollow fiber membranes and vibrate the hollow fiber membranes to remove the adhering substances (refer to Japanese Unexamined Patent Application Publication No. 2010-42329).

### CITATION LIST

### Patent Literature

PTL 1: Japanese Unexamined Patent Application Publication No. 2010-42329

### SUMMARY OF INVENTION

### Solution to Problem

In general, air bubbles for cleaning the surfaces of the hollow fiber membranes are continuously supplied to keep the surfaces of the hollow fiber membranes clean. Thus, if the cleaning efficiency at which the surfaces of the hollow fiber membranes are cleaned by air bubbles is degraded, the energy needed to supply air bubbles for cleaning may increase and the filtration cost may rise. To reduce the filtration cost, an approach has been taken in which multiple filtration modules are connected in a vertical direction. However, air bubbles may diffuse due to holding members (the components that join the filtration modules) that hold the hollow fiber membranes, the surfaces of the hollow fiber membranes in the upper part may not come into contact with air bubbles, and the cleaning ability may be degraded as a result.

The present invention has been made under these circumstances and aims to provide a filtration module and a filtration apparatus that have excellent hollow fiber membrane surface cleaning efficiency and excellent filtration ability.

### Solution to Problem

A filtration module according to one embodiment of the present invention made to address the issue described above includes plural hollow fiber membranes held while being aligned in one direction and a pair of holding members that fix both ends of the hollow fiber membranes. In the holding members, an existence region where the hollow fiber membranes exist has a rectangular shape in a direction perpendicular to the direction in which the hollow fiber membranes are aligned. The hollow fiber membranes are arranged in a matrix in a long side direction and a short side direction of the existence region. In the existence region, a ratio of an average pitch of the hollow fiber membranes in the long side direction to an average pitch of the hollow fiber membranes in the short side direction is 1.2 or more and 2.5 or less.

### Advantageous Effects of Invention

The filtration module according to an embodiment of the present invention has excellent hollow fiber membrane surface cleaning effect and excellent filtration ability.

### BRIEF DESCRIPTION OF DRAWINGS

FIG. 1 is a schematic perspective view of a filtration module according to one embodiment of the present invention.

FIG. 2 is a schematic end view of a holding member of the filtration module illustrated in FIG. 1.

FIG. 3 is a schematic cross-sectional view of a hollow fiber membrane of the filtration module illustrated in FIG. 1.

FIG. 4 is a schematic partial cross-sectional view of the filtration module illustrated in FIG. 1.

FIG. 5 is a schematic diagram showing the structure of a filtration apparatus according to one embodiment of the present invention.

### REFERENCE SIGNS LIST

1 filtration module
2 hollow fiber membrane
2a support layer
2b filtration layer
3 upper holding member
3a hollow casing
3b resin composition
4 lower holding member
11 filtration vessel
12 air bubble supply unit
13 discharge duct
14 suction pump
A existence region
B air bubbles
La average length in the long side direction
Lb average length in the short side direction
Lt average effective length
Pa average pitch in the long side direction
Pb average pitch in the short side direction

### DESCRIPTION OF EMBODIMENTS

### [Description of Embodiments of the Present Invention]

A filtration module according to one aspect of the present invention includes a plurality of hollow fiber membranes held while being aligned in one direction and a pair of holding members that fix both ends of the hollow fiber membranes. In the holding members, an existence region where the hollow fiber membranes exist has a rectangular shape in a direction perpendicular to the direction in which the hollow fiber membranes are aligned. The hollow fiber membranes are arranged in a matrix in a long side direction and a short side direction of the existence region. In the existence region, a ratio of an average pitch of the hollow fiber membranes in the long side direction to an average pitch of the hollow fiber membranes in the short side direction is 1.2 or more and 2.5 or less.

The filtration module has relatively high filtration ability because the hollow fiber membranes are arranged in a matrix in a rectangular existence region and thus the surface area of the hollow fiber membranes per facility area, in other words, the filtration area, is large. Moreover, in the existence region, the ratio of the average pitch of the hollow fiber membranes in the long side direction to the average pitch of the hollow fiber membranes in the short side direction is within the above-described range. Thus, air bubbles can in the short side direction, in other words, the direction in which the thickness of the bundle of the hollow fiber membranes is small, and relatively easily enter the interior of the bundle of the hollow fiber membranes. As a result, according to the filtration module, air bubbles can be supplied to the central portion of the bundle of the hollow fiber membranes, the surfaces of the hollow fiber membranes can be highly efficiently cleaned by air scrubbing, and the filtration capacity can be maintained.

The number of the hollow fiber membranes in one row extending in the short side direction is preferably 8 or more and 50 or less. When the number of the hollow fiber membranes in one row extending in the short side direction is within this range, air bubbles can more assuredly enter the central portion of the bundle of the hollow fiber membranes while the surface area of the hollow fiber membranes is maintained.

The packing area ratio of the hollow fiber membranes in the existence region is preferably 20% or more and 60% or less. When the packing area ratio of the hollow fiber membranes in the existence region is within this range, the filtration flow rate per facility area can be increased while maintaining the cleaning effect at the inner side of the existence region.

The ratio of the average pitch of the hollow fiber membranes in the short side direction to an average outer diameter of the hollow fiber membranes is preferably 1 or more and 1.5 or less. When the ratio of the average pitch in the short side direction to the average outer diameter of the hollow fiber membranes is within this range, the density of the hollow fiber membranes in the short side direction is increased while the efficiency of forming gaps through which air bubbles can move in the short side direction is maintained. Thus, the filtration area can be increased and the filtration flow rate per facility area can be increased.

The average outer diameter of the hollow fiber membranes is preferably 1 mm or more and 6 mm or less. When the average outer diameter of the hollow fiber membranes is within this range, vibration and titubation of the hollow fiber membranes that promote entry of the air bubbles can be facilitated while securing the strength of the hollow fiber membranes.

The hollow fiber membranes may each include a support layer containing polytetrafluoroethylene as a main component and a filtration layer stacked on a surface of the support layer and containing polytetrafluoroethylene as a main component. Because the hollow fiber membranes have a support layer and a filtration layer both containing polytetrafluoroethylene as a main component, the hollow fiber membranes have sufficient mechanical strength.

The filtration layer is preferably formed by wrapping an expanded polytetrafluoroethylene sheet around an expanded polytetrafluoroethylene tube that constitutes a support layer, and performing sintering. Because the hollow fiber membranes are formed by wrapping an expanded polytetrafluoroethylene sheet around an expanded polytetrafluoroethylene tube that constitutes a support layer and then performing sintering, adjustment of the shape and size of the pores in the hollow fiber membranes is facilitated and pores in the support layer and the filtration layer become connected to one another to improve permeability.

At least one of the pair of holding members preferably includes a hollow casing into which ends of the hollow fiber membranes are inserted and a resin composition containing an epoxy resin or a urethane resin as a main component preferably fills the space between an inner side wall surface of the hollow casing and outer circumferential surfaces of the hollow fiber membranes. When a resin composition containing an epoxy resin or a urethane resin as a main component fills the space between an inner side wall surface of the hollow casing and outer circumferential surfaces of the hollow fiber membranes as such, the gaps between the hollow casing and the hollow fiber membranes can be sealed, the outer side and the inner side of the hollow fiber membranes can be assuredly isolated from each other, and the hollow fiber membranes can be held and prevented from falling even when large vibrations occur by contact with air bubbles.

A filtration apparatus according to an embodiment of the present invention includes the filtration module, a filtration tank that houses the filtration module, and an air bubble supply unit that supplies air bubbles to a lower portion of the filtration module.

The filtration apparatus is equipped with the filtration module, which has excellent hollow fiber membrane surface cleaning efficiency and excellent filtration ability, and the hollow fiber membranes can be cleaned by air scrubbing using an air bubble supply unit; hence, the filtration ability can be enhanced and the utilization rate can be increased.

Here, the “existence region” refers to the smallest in area among imaginary convex polygons (polygons with all inner angles smaller than 180°) that contain all hollow fiber membranes when viewed in the alignment direction of the hollow fiber membranes. The term “rectangular” refers to a quadrilateral with unequal adjacent sides and does not include squares. The “packing area ratio” refers to the area fraction of the inner side of the outer circumferential surfaces of the hollow fiber membranes and is an occupying ratio including the area of the inner cavities of the hollow fiber membranes.

### [Details of Embodiments of the Present Invention]

The individual embodiments of the present invention will now be described in detail with reference to the drawings.

### [Filtration Module]

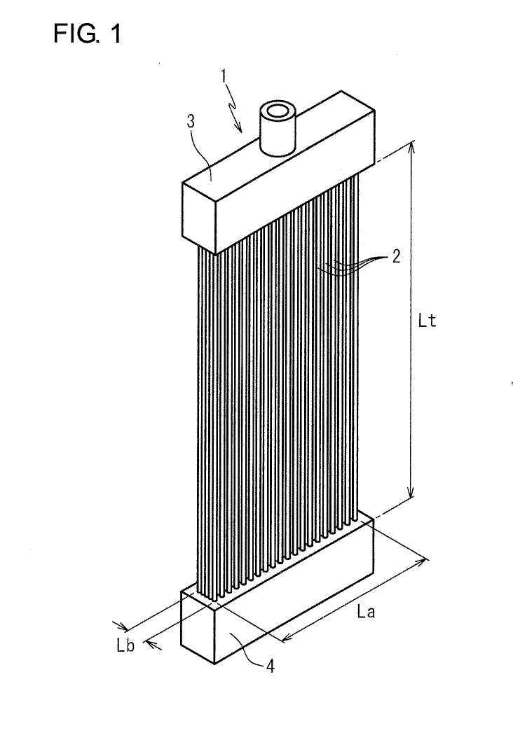

A filtration module 1 illustrated in FIG. 1 includes hollow fiber membranes 2 that are held by being aligned in one direction and a pair of holding members that fix both ends of the hollow fiber membranes 2, namely, an upper holding member 3 and a lower holding member 4.

### <Hollow Fiber Membranes>

The hollow fiber membranes 2 are prepared by forming porous membranes, which allow water to penetrate through but not particles contained in liquid to be treated, into tubes.

The hollow fiber membranes 2 may contain a thermoplastic resin as a main component. Examples of the thermoplastic resin include polyethylene, polypropylene, polyvinylidene fluoride, ethylene-vinyl alcohol copolymers, polyamide, polyimide, polyetherimide, polystyrene, polysulfone, polyvinyl alcohol, polyphenylene ether, polyphenylene sulfide, acetylcellulose, polyacrylonitrile, and polytetrafluoroethylene (PTFE). Among these, PTFE, which has excellent chemical resistance, heat resistance, weather resistance, and flame resistance and is porous, is preferable and monoaxially or biaxially expanded PTFE is more preferable. The material for forming the hollow fiber membranes may contain other polymers and additives such as a lubricant and the like.

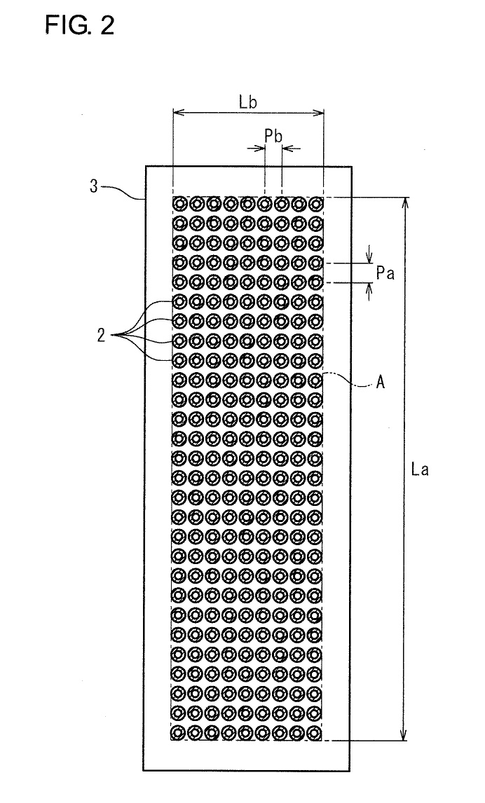

As illustrated in FIG. 2, an existence region A in the upper holding member 3 (and the lower holding member 4) where the hollow fiber membranes 2 exist has a rectangular shape in a direction perpendicular to the alignment direction. Preferably, the hollow fiber membranes 2 are arranged into a matrix in a long side direction and a short side direction of the existence region A.

The lower limit of the ratio (La/Lb) of the average length La of the existence region A in the long side direction to the average length Lb in the short side direction is preferably 10, more preferably 15, and yet more preferably 20. The upper limit of the ratio of the average length La of the existence region A in the long side direction to the average length Lb in the short side direction is preferably 50, more preferably 45, and yet more preferably 40. When the ratio of the average length La in the long side direction to the average length Lb in the short side direction is below the lower limit, the length in the short side direction is excessively large and air bubbles may not be supplied to the central portion of the bundle of the hollow fiber membranes 2 and the area of the existence region A may become so small that a sufficient filtration area can no longer be obtained. In contrast, when the ratio of the average length La of the existence region A in the long side direction to the average length Lb in the short side direction exceeds the upper limit, the filtration module 1 is excessively elongated in the long side direction and handling may become difficult.

The lower limit of the ratio (Pa/Pb) of the average pitch Pa of the hollow fiber membranes 2 in the long side direction to the average pitch Pb in the short side direction is 1.2 and is preferably 1.5. The upper limit of the ratio of the average pitch Pa of the hollow fiber membranes 2 in the long side direction to the average pitch Pb in the short side direction is 2.5 and is preferably 2. When the ratio of the average pitch Pa of the hollow fiber membranes 2 in the long side direction to the average pitch Pb in the short side direction is below the lower limit, a sufficient amount of air bubbles may not be supplied to gaps between the hollow fiber membranes 2 in the short side direction of the existence region A. Conversely, when the ratio of the average pitch Pa of the hollow fiber membranes 2 in the long side direction to the average pitch Pb in the short side direction exceeds the upper limit, the density of the hollow fiber membranes 2 in the long side direction is decreased and the filtration ability may become insufficient.

The lower limit of the ratio (Lt/Lb) of the average effective length Lt of the hollow fiber membranes 2 to the average length Lb of the existence region A in the short side direction is preferably 40, more preferably 50, and yet more preferably 60. The upper limit of the ratio of the average effective length Lt of the hollow fiber membranes 2 to the average length Lb of the existence region A in the short side direction is preferably 200, more preferably 150, and yet more preferably 120. When the ratio of the average effective length Lt of the hollow fiber membranes 2 to the average length Lb of the existence region A in the short side direction is below the lower limit, the hollow fiber membranes 2 bend excessively less, titubation of the hollow fiber membranes 2 due to air bubble abrasion becomes insufficient, and air bubbles may not be supplied to the hollow fiber membranes 2 located at the center of the existence region A. Conversely, when the ratio of the average effective length Lt of the hollow fiber membranes 2 to the average length Lb of the existence region A in the short side direction exceeds the upper limit, the hollow fiber membranes 2 bend excessively and the filtration efficiency and cleaning efficiency may be degraded due to entanglement of the hollow fiber membranes 2. The average effective length Lt of the hollow fiber membranes 2 refers to the average of the lengths of the portions of the hollow fiber membranes 2 that are exposed between the upper holding member 3 and the lower holding member 4.

The lower limit of the packing area ratio of the hollow fiber membranes 2 in the existence region A is preferably 20% and more preferably 30%. The upper limit of the packing area ratio of the hollow fiber membranes 2 in the existence region A is preferably 60% and more preferably 55%. When the packing area ratio of the hollow fiber membranes 2 is below the lower limit, the number of hollow fiber membranes 2 per unit area is decreased and sufficient filtration efficiency may not be obtained. In contrast, when the packing area ratio of the hollow fiber membranes 2 exceeds the upper limit, the gaps between the hollow fiber membranes 2 become excessively small and air bubbles may not be supplied to the hollow fiber membranes 2 on the inner side of the existence region A.

The lower limit of the number of hollow fiber membranes 2 arranged in the short side direction (the number of hollow fiber membranes in one row extending in the short side direction) in the existence region A is preferably 8 and more preferably 12. The upper limit of the hollow fiber membranes 2 arranged in the short side direction is preferably 50 and more preferably 40. When the number of hollow fiber membranes 2 arranged in the short side direction is below the lower limit, the filtration area per facility area may not be sufficiently obtained. In contrast, when the number of hollow fiber membranes 2 arranged in the short side direction exceeds the upper limit, it becomes difficult to supply air bubbles to the central portion of the bundle of the hollow fiber membranes 2 in the short side direction and a sufficient cleaning effect may not be obtained.

The lower limit of the ratio of the average pitch Pb in the short side direction to the average outer diameter of the hollow fiber membranes 2 is preferably 1. The upper limit of the ratio of the average pitch Pb in the short side direction to the average outer diameter of the hollow fiber membranes 2 is preferably 1.5 and more preferably 1.4. When the ratio of the average pitch Pb in the short side direction to the average outer diameter of the hollow fiber membranes 2 is below the lower limit, the hollow fiber membranes 2 are arranged to be in a squashed state in the radial direction, thereby posing a difficulty in manufacturing. In contrast, when the ratio of the average pitch Pb in the short side direction to the average outer diameter of the hollow fiber membranes 2 exceeds the upper limit, the density of the hollow fiber membranes 2 in the long side direction is decreased and thus filtration ability may become insufficient.

The lower limit of the average outer diameter of the hollow fiber membranes 2 is preferably 1 mm, more preferably 1.5 mm, and yet more preferably 2 mm. The upper limit of the average outer diameter of the hollow fiber membranes 2 is preferably 6 mm, more preferably 5 mm, and yet more preferably 4 mm. When the average outer diameter of the hollow fiber membranes 2 is below the lower limit, the mechanical strength of the hollow fiber membranes 2 may become insufficient. Conversely, when the average outer diameter of the hollow fiber membranes 2 exceeds the upper limit, flexibility of the hollow fiber membranes 2 becomes insufficient and vibration or titubation of the hollow fiber membranes 2 caused by contact with air bubbles may become insufficient. Furthermore, the gaps between the hollow fiber membranes 2 may not expand and air bubbles may not be introduced to the hollow fiber membranes 2 located on the inner side of the existence region A. There is also a possibility that the ratio of the surface area to the cross-sectional area of the hollow fiber membranes 2 may become small and the filtration efficiency may be degraded thereby.

The lower limit of the average inner diameter of the hollow fiber membranes 2 is preferably 0.3 mm, more preferably 0.5 mm, and yet more preferably 0.9 mm. The upper limit of the average inner diameter of the hollow fiber membranes 2 is preferably 4 mm and more preferably 3 mm. When the average inner diameter of the hollow fiber membranes 2 is below the lower limit, pressure drop during the process of discharging the filtrated liquid inside the hollow fiber membranes 2 may increase. In contrast, when the average inner diameter of the hollow fiber membranes 2 exceeds the upper limit, the thickness of the hollow fiber membranes 2 is decreased and mechanical strength and impurity permeation preventing effect may become insufficient.

The lower limit of the ratio of the average inner diameter to the average outer diameter of the hollow fiber membranes 2 is preferably 0.3 and more preferably 0.4. The upper limit of the ratio of the average inner diameter to the average outer diameter of the hollow fiber membranes 2 is preferably 0.8 and more preferably 0.6. When the ratio of the average inner diameter to the average outer diameter of the hollow fiber membranes 2 is below the lower limit, the thickness of the hollow fiber membranes 2 increases excessively and the permeability of the hollow fiber membranes 2 may be degraded. In contrast, when the ratio of the average inner diameter to the average outer diameter of the hollow fiber membranes 2 exceeds the upper limit, the thickness of the hollow fiber membranes 2 decreases and the mechanical strength and impurity permeation preventing effect may become insufficient.

The lower limit of the average effective length Lt of the hollow fiber membranes 2 is preferably 1 m and more preferably 2 m. The upper limit of the average effective length Lt of the hollow fiber membranes 2 is preferably 6 m and more preferably 5 m. When the average effective length Lt of the hollow fiber membranes 2 is below the lower limit, titubation of the hollow fiber membranes 2 caused by abrasion with air bubbles is insufficient and the gaps between the hollow fiber membranes 2 may not expand to allow air bubbles to reach the hollow fiber membranes 2 located on the inner side of the existence region A. In contrast, when the average effective length Lt of the hollow fiber membranes 2 exceeds the upper limit, the hollow fiber membranes 2 may undergo excessive bending due to their own weight and handling ease of installing the filtration module 1 etc., may be degraded.

The lower limit of the ratio (aspect ratio) of the average effective length Lt to the average outer diameter of the hollow fiber membranes 2 is preferably 150 and more preferably 1000. The upper limit of the aspect ratio of the hollow fiber membranes 2 is preferably 6000 and more preferably 5000. When the aspect ratio of the hollow fiber membranes 2 is below the lower limit, the thickness of the bundle of the hollow fiber membranes 2 in the short side direction increases and the effect of introducing air bubbles in the short side direction into the inner side of the bundle of the hollow fiber membranes 2 caused by titubation of the hollow fiber membranes 2 may become insufficient. In contrast, when the aspect ratio of the hollow fiber membranes 2 exceeds the upper limit, the hollow fiber membranes 2 are excessively oblong and thus mechanical strength may decrease when the hollow fiber membranes 2 are held taut in vertical directions.

The lower limit of the porosity of the hollow fiber membranes 2 is preferably 70% and more preferably 75%. The upper limit of the porosity of the hollow fiber membranes 2 is preferably 90% and more preferably 85%. When the porosity of the hollow fiber membranes 2 is below the lower limit, permeability is degraded and the filtration ability of the filtration module 1 may be degraded. In contrast, when the porosity of the hollow fiber membranes 2 exceeds the upper limit, the mechanical strength and abrasion resistance of the hollow fiber membranes 2 may become insufficient. The porosity refers to the ratio of the total volume of pores to the volume of the hollow fiber membranes 2 and can be determined by measuring the density of the hollow fiber membranes 2 according to ASTM-D-792.

The lower limit of the area occupying ratio of the pores in the hollow fiber membranes 2 is preferably 40%. The upper limit of the area occupying ratio of the pores in the hollow fiber membranes 2 is preferably 60%. When the area occupying ratio of the pores is below the lower limit, permeability may be degraded and the filtration ability of the filtration module 1 may be degraded. In contrast, when the area occupying ratio of the pores exceeds the upper limit, the surface strength of the hollow fiber membranes 2 may be insufficient and rupture or the like of the hollow fiber membranes 2 may occur due to abrasion with air bubbles. The area occupying ratio refers to the ratio of the total area of the pores in the outer circumferential surfaces (filtration layer surfaces) of the hollow fiber membranes 2 relative to the surface area of the hollow fiber membranes 2 and can be determined by analyzing an electron micrographic image of the outer circumferential surfaces of the hollow fiber membranes 2.

The lower limit of the average diameter of the pores of the hollow fiber membranes 2 is preferably 0.01 μμm. The upper limit of the average diameter of the pores of the hollow fiber membranes 2 is preferably 0.45 μm and more preferably 0.1 μm. When the average diameter of the pores of the hollow fiber membranes 2 is below the lower limit, permeability may be degraded. When the average diameter of the pores of the hollow fiber membranes 2 exceeds the upper limit, permeation of the impurities contained in the liquid to be treated into the interior of the hollow fiber membranes 2 may not be prevented. The average diameter of the pores refers to the average diameter of the pores in the outer circumferential surfaces (surfaces of filtration layers) of the hollow fiber membranes 2 and can be measured with a pore size distribution analyzer (for example, a porous material automatic pore size distribution measuring system available from Porous Materials Incorporated).

The lower limit of the tensile strength of the hollow fiber membranes 2 is preferably 50 N and more preferably 60 N. When the tensile strength of the hollow fiber membranes 2 is below the lower limit, durability to withstand surface cleaning with air bubbles may be degraded. The upper limit of the tensile strength of the hollow fiber membranes 2 is typically 150 N. The tensile strength refers to a maximum tensile stress observed in a tensile test conducted according to JIS K 7161 (1994) at a gauge length of 100 mm and a test speed of 100 mm/min.

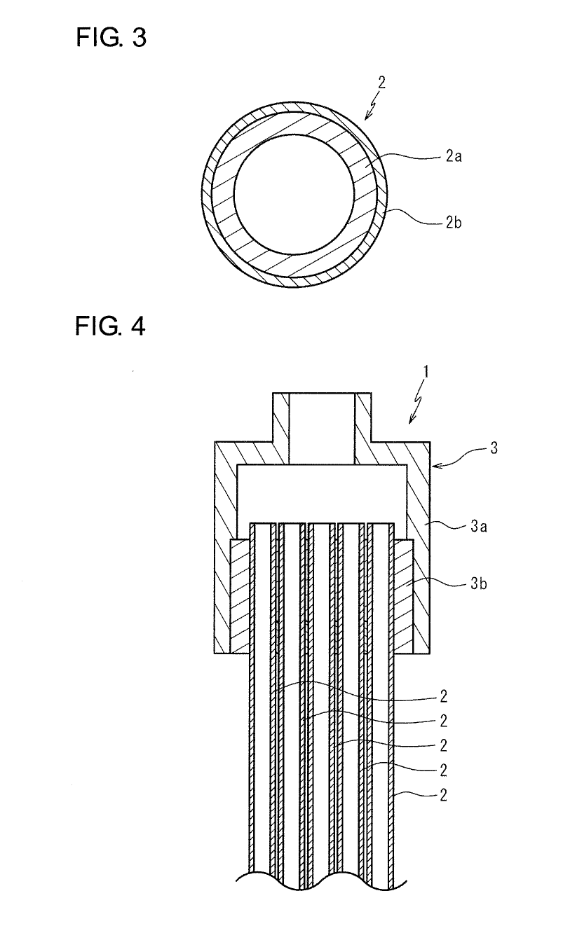

The hollow fiber membranes 2 preferably have a multilayer structure. For example, as illustrated in FIG. 3, a hollow fiber membrane 2 may include a tubular support layer 2a and a filtration layer 2b stacked on a surface of the support layer 2a. When a hollow fiber membrane 2 has such a multilayer structure, permeability as well as mechanical strength can be achieved and the surface cleaning effect by air bubbles can be enhanced.

The materials constituting the support layer 2a and the filtration layer 2b may contain polytetrafluoroethylene (PTFE) as a main component. When the main component of the materials that constitute the support layer 2a and the filtration layer 2b is PTFE, the hollow fiber membranes 2 exhibit excellent mechanical strength and damage and the like on the surface of the hollow fiber membranes resulting from abrasion with air bubbles are reduced.

The lower limit of the number-average molecular weight of PTFE used in the support layer 2a and the filtration layer 2b is preferably 500,000 and more preferably 2,000,000. The upper limit of the number-average molecular weight of PTFE used in the support layer 2a and the filtration layer 2b is preferably 20,000,000. When the number-average molecular weight of PTFE is below the lower limit, the surfaces of the hollow fiber membranes 2 may be damaged by abrasion with air bubbles and mechanical strength of the hollow fiber membranes 2 may be degraded. When the number-average molecular weight of PTFE exceeds the upper limit, it may become difficult to form pores in the hollow fiber membranes 2.

The support layer 2a may be a tube prepared by extrusion-molding PTFE, for example. When an extrusion-molded tube is used as the support layer 2a, the support layer 2a exhibits mechanical strength and pores can be easily formed. This tube is preferably expanded at an expansion ratio of 50% or more and 700% or less in the axial direction and 5% or more and 100% or less in the circumferential direction.

The temperature for expansion is preferably not higher than the melting point of the tube material, for example, 0° C. or higher and 300° C. or lower. In order to obtain a porous material that includes pores having a relatively large diameter, low-temperature expansion is preferable. In order to obtain a porous material that includes pores having a relatively small diameter, high-temperature expansion is preferable. The expanded porous material is heat-treated at a temperature of 200° C. or higher and 300° C. or lower for, for example, 1 to 30 minutes while both ends are fixed to keep the expanded state; as a result, high dimensional stability is obtained. The size of the pores of the porous material can be adjusted by the combination of conditions such as expansion temperature, expansion ratio, etc.

The tube that forms the support layer 2a can be obtained by, for example, adding a liquid lubricant, such as naphtha, to PTFE fine powder, extrusion-molding the resulting mixture into a tube, and expanding the tube. Dimensional stability can be improved when the tube is held at a temperature not lower than the melting point of the PTFE fine powder, for example, 350° C. or higher and 550° C. or lower, in a heating furnace for several tens of seconds to several minutes to conduct sintering.

The average thickness of the support layer 2a is preferably 0.1 mm or more and 3 mm or less. When the average thickness of the support layer 2a is within this range, the hollow fiber membranes 2 strike good balance between mechanical strength and permeability.

The filtration layer 2b can be formed by, for example, wrapping a PTFE sheet around the support layer 2a and performing sintering. When a sheet is used as a material for forming the filtration layer 2b, expansion can be facilitated, the shape and size of pores can be easily adjusted, and the thickness of the filtration layer 2b can be decreased. Since the sheet is wrapped around and sintered, the support layer 2a and the filtration layer 2b become integral and the pores in these layers can be caused to connect to one another to improve permeability. The sintering temperature is preferably not lower than the melting points of the tube that fort is the support layer 2a and the sheet that forms the filtration layer 2b.

The sheet that forms the filtration layer 2b can be obtained by, for example, (1) a method with which an unsintered molded body obtained by extrusion of resin is expanded at a temperature not higher than the melting temperature and then sintered or (2) a method with which a sintered resin molded body is slowly cooled to increase crystallinity and the resulting cooled sintered molded body is expanded. This sheet is preferably expanded at an expansion ratio of 50% or more and 1000% or less in a longitudinal direction and 50% or more and 2500% or less in a transversal direction. In particular, when the expansion ratio in the transversal direction is within this range, the mechanical strength in the circumferential direction as the sheet is wrapped around can be improved and durability that withstands the surface cleaning with air bubbles can be improved.

When the filtration layer 2b is made by wrapping a sheet around the tube that forms the support layer 2a, fine irregularities are preferably formed on the outer circumferential surface of the tube. When irregularities are formed on the outer circumferential surface of the tube, misalignment with the sheet can be prevented, adhesion between the tube and the sheet can be improved, and detachment of the filtration layer 2b from the support layer 2a due to air bubble cleaning can be prevented. The number of times the sheet is wrapped around can be adjusted according to the thickness of the sheet. The number of times may be one or more than one. More than one sheets may be wrapped around the tube. The method for wrapping the sheet is not particularly limited. The sheet may be wrapped in the circumferential direction of the tube or may be spirally wrapped.

The height (level difference) in the fine irregularities is preferably 20 μm or more and 200 μm or less. The fine irregularities are preferably formed in all parts of the outer circumferential surface of the tube but may be formed in some parts only or intermittently. Examples of the method for forming the fine irregularities on the tube outer circumferential surface include a surface treatment that uses flame, laser irradiation, plasma irradiation, and dispersion coating of a fluororesin or the like. The surface treatment that uses flame is preferable since irregularities can be easily formed without affecting the tube physical properties.

Alternatively, an unsintered tube and an unsintered sheet may be used and sintering may be conducted after the sheet is wrapped around the tube so as to increase adhesion between the tube and the sheet.

The average thickness of the filtration layer 2b is preferably 5 μm or more and 100 μm or less. When the average thickness of the filtration layer 2b is within this range, high filtration ability can be given to the hollow fiber membranes 2 easily and assuredly.

### <Upper Holding Member>

The upper holding member 3 is a member that holds upper ends of the hollow fiber membranes 2 and has a discharge portion (water collecting header) that is in communication with inner cavities of the hollow fiber membranes 2 and collects the filtered liquid. A discharge duct is connected to this discharge portion so that the filtered liquid penetrated into the interior of the hollow fiber membranes 2 is discharged. The outer shape of the upper holding member 3 may be any. For example, the cross-sectional shape may be polygonal or circular.

As illustrated in FIG. 4, the upper holding member 3 includes a hollow casing 3a that has its lower part open and the upper ends of the hollow fiber membranes 2 are inserted to the hollow casing 3a from below. The upper holding member 3 includes a resin composition 3b filling between the inner side wall surface of the hollow casing 3a and the outer circumferential surfaces of the hollow fiber membranes 2 in such a way as to leave an inner space that forms the discharge portion. Specifically, a bundle of the hollow fiber membranes 2 having upper ends bonded together with the resin composition 3b in advance is inserted into the hollow casing 3a and the resin composition 3b is additionally supplied to fill the gaps in the resin composition 3b and gaps between the inner wall of the hollow casing 3a and the resin composition 3b. As a result, the hollow fiber membranes 2 are fixed with respect to the hollow casing 3a. The bundle of the hollow fiber membranes 2 may be divided into two or more parts.

Examples of the material for the hollow casing 3a include resin compositions that contain PTFE, vinyl chloride, polyethylene, ABS resin, or the like as a main component.

The resin composition 3b may be any resin composition that has high adhesion to the hollow fiber membranes 2 and the hollow casing 3a and is capable of being cured within the hollow casing 3a. In particular, when hollow fiber membranes 2 composed of PTFE are used, the main component of the resin composition 3b is preferably an epoxy resin or a urethane resin capable of reliably preventing detachment of the hollow fiber membranes 2 and having high adhesion to the PTFE. When the hollow casing 3a is filled with the resin composition 3b, space between the hollow fiber membranes 2 and the side wall of the hollow casing 3a can be hermetically sealed. As a result, the discharge portion inside the upper holding member 3 and the outer side of the hollow fiber membranes 2 can be reliably separated and thus contamination of the filtered liquid with unfiltered liquid to be treated can be prevented.

The lower limit of the average filling thickness of the resin composition 3b in the direction of the alignment of the hollow fiber membranes 2 is preferably 20 mm and more preferably 30 mm. The upper limit of the average filling thickness of the resin composition 3b is preferably 60 mm and more preferably 50 mm. When the average filling thickness of the resin composition 3b is below the lower limit, the gap between the hollow fiber membranes 2 and the side wall of the hollow casing 3a may not be sufficiently sealed and the hollow fiber membranes 2 may fall off from the layer of the resin composition 3b. In contrast, when the average charging thickness of the resin composition 3b exceeds the upper limit, the size and weight of the upper holding member 3 may increase unnecessarily.

The lower holding member 4 is a holding member that holds lower ends of the hollow fiber membranes 2. The lower holding member 4 may have a similar structure to the upper holding member 3 or may be without a discharge portion that seals the lower ends of the hollow fiber membranes 2. The material for the lower holding member 4 may be the same as that for the upper holding member 3.

The lower holding member 4 may have a structure in which one hollow fiber membrane 2 is bent in a U shape. In such a case, the upper holding member 3 hold both ends of the hollow fiber membranes 2.

In order to facilitate handling (transportation, installation, replacement, etc.) of the filtration module 1, the upper holding member 3 and the lower holding member 4 may be joined together with a joining member. Examples of the joining member include metal supporting rods and resin casings (outer cylinders).

### [Advantages]

The filtration module 1 includes hollow fiber membranes 2 arranged in a matrix in a rectangular existence region A and the ratio of the average pitch Pb of the hollow fiber membranes 2 in the long side direction to the average pitch Pa in the short side direction is 1.2 or more and 1.5 or less. Thus, the filtration area per unit facility area is large and filtration ability is excellent. According to the filtration module 1, air bubbles can relatively easily enter the inner side of the bundle of the hollow fiber membranes 2 and the surfaces of the hollow fiber membranes 2 can be efficiently cleaned by air scrubbing. As a result, the filtration module 1 has excellent efficiency for cleaning the surfaces of the hollow fiber membranes 2 and excellent filtration ability.

### [Filtration Apparatus]

A filtration apparatus equipped with the filtration module 1 illustrated in FIG. 1 will now be described.

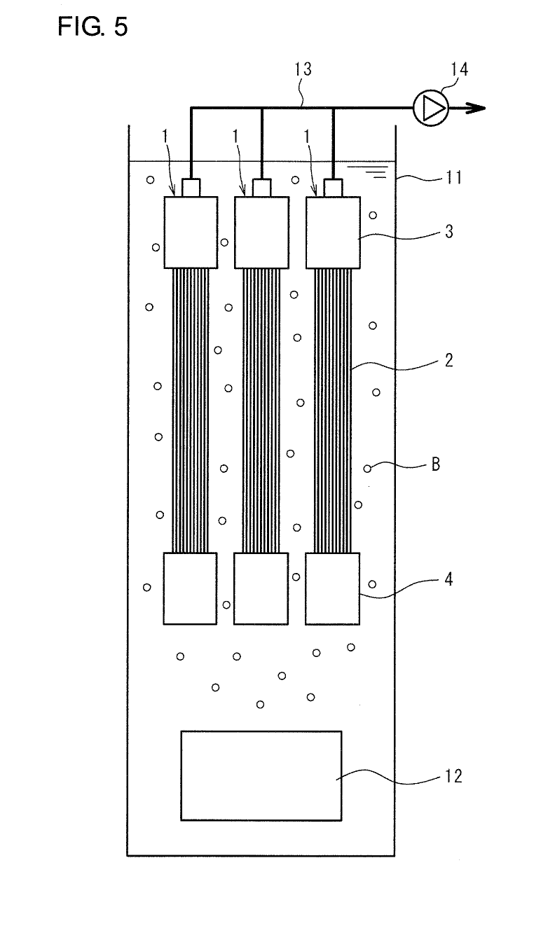

A filtration apparatus illustrated in FIG. 5 includes multiple filtration modules 1 described above, a filtration vessel 11 that houses these filtration modules 1, and an air bubble supply unit 12 that supplies air bubbles from below the filtration modules 1. The filtration apparatus is also equipped with a suction pump 14 that suctions the treated liquid filtered through the hollow fiber membranes 2 through a discharge duct 13 connected to the discharge portion of each filtration module 1.

In the filtration apparatus, the multiple filtration modules 1 are arranged side-by-side while being spaced from one another in the short side direction. In other words, the drawing of FIG. 5 illustrates the filtration apparatus viewed in the long side direction of the filtration modules 1.

### <Filtration Vessel>

The filtration vessel 11 stores the liquid to be treated so as to have the filtration modules 1 immersed in the liquid to be treated.

A frame formed of metal or the like may be placed in the filtration vessel 11 to support the filtration modules 1 and the air bubble supply unit 12. Examples of the material of the filtration vessel 11 include resin, metal, and concrete.

### <Air Bubble Supply Unit>

The air bubble supply unit 12 supplies, from below the filtration modules 1, air bubbles B that clean the surfaces of the hollow fiber membranes 2. These air bubbles B clean the surfaces of the hollow fiber membranes 2 as they move up, abrading the surfaces of the hollow fiber membranes 2.

The air bubble supply unit 12 together with the filtration modules 1 are immersed in the liquid to be treated stored in the filtration vessel 11 and supplies air bubbles B by continuously or intermittently discharging gas supplied from a compressor or the like through a supply duct (not shown).

The air bubble supply unit 12 may be any known aeration equipment. Examples of the aeration equipment include aeration equipment that uses a porous plate or porous tube in which a large number of pores are formed in a resin or ceramic plate or tube, jet-type aeration equipment that jets out gas from a diffuser or sparger, intermittent bubble jetting aeration equipment that intermittently jets out air bubbles, and a bubbling jet nozzle that jets out water stream mixed with air bubbles.

An example of the intermittent bubble jetting aeration equipment is a combination of a device that stores the gas continuously supplied from a compressor or the like through a gas supply duct (not illustrated) and intermittently discharges the gas after reaching a particular volume to supply air bubbles, and a component, such as a mesh, that breaks down the supplied air bubbles.

The gas that forms air bubbles supplied from the air bubble supply unit 12 may be any inert gas and is preferably air from the viewpoint of operating cost.

### [Advantages]

The filtration apparatus includes the filtration modules 1, the filtration vessel 11 that houses the filtration modules 1, and the air bubble supply unit 12 that supplies air bubbles from below the filtration modules 1. Thus, the liquid to be treated in the filtration vessel 11 can be filtered by using the filtration modules 1. Since air bubbles are supplied to the filtration modules 1 from the air bubble supply unit 12, the hollow fiber membranes 2 in the filtration modules 1 are air-scrubbed and maintain the filtration ability. In particular, since the cleaning effect on the filtration modules 1 with air bubbles is high, the filtration ability is also high and the utilization rate can be increased.

### [Other Embodiments]

The embodiments disclosed herein are merely exemplary in all respects and should not be considered as limiting. The scope of the present invention is not limited to the structures of the embodiments described above but by the claims and is intended to include all modifications within the meaning and the scope of the claims and their equivalents.

The filtration module is applicable not only to the filtration apparatus of the immersion suction type described above but also to various filtration apparatuses such as pressured cross-flow filtration apparatuses.

In the filtration module, the upper holding member may seal the hollow fiber membranes and the lower holding member may have a discharge portion.

In the filtration apparatus, the number of filtration modules may be any number including 1. When the filtration apparatus is equipped with multiple filtration modules, one air bubble supply unit may be provided below for each of the filtration modules or one air bubble supply unit capable of supplying air bubbles to the multiple filtration modules may be provided.

### INDUSTRIAL APPLICABILITY

The filtration module and the filtration apparatus are suitable for use as solid-liquid separation treatment apparatuses in various field.

1. A filtration module comprising a plurality of hollow fiber membranes held while being aligned in one direction and a pair of holding members that fix both ends of the hollow fiber membranes,
wherein, in the holding members, an existence region where the hollow fiber membranes exist has a rectangular shape in a direction perpendicular to the direction in which the hollow fiber membranes are aligned,
the hollow fiber membranes are arranged in a matrix in a long side direction and a short side direction of the existence region, and
in the existence region, a ratio of an average pitch of the hollow fiber membranes in the long side direction to an average pitch of the hollow fiber membranes in the short side direction is 1.2 or more and 2.5 or less.

2. The filtration module according to claim 1, wherein the number of the hollow fiber membranes in one row extending in the short side direction is 8 or more and 50 or less.

3. The filtration module according to claim 1, wherein a packing area ratio of the hollow fiber membranes in the existence region is 20% or more and 60% or less.

4. The filtration module according to claim 1, wherein a ratio of the average pitch of the hollow fiber membranes in the short side direction to an average outer diameter of the hollow fiber membranes is 1 or more and 1.5 or less.

5. The filtration module according to claim 1, wherein an average outer diameter of the hollow fiber membranes is 1 mm or more and 6 mm or less.

6. The filtration module according to claim 1, wherein the hollow fiber membranes each include a support layer containing polytetrafluoroethylene as a main component and a filtration layer that is stacked on a surface of the support layer and contains polytetrafluoroethylene as a main component.

7. The filtration module according to claim 6, wherein the filtration layer is formed by wrapping an expanded polytetrafluoroethylene sheet around an expanded polytetrafluoroethylene tube that constitutes the support layer, and conducting sintering.

8. The filtration module according to claim 1, wherein at least one of the pair of holding members includes a hollow casing into which ends of the hollow fiber membranes are inserted and a resin composition containing an epoxy resin or a urethane resin as a main component fills between an inner side wall surface of the hollow casing and outer circumferential surfaces of the hollow fiber membranes.

9. A filtration apparatus comprising the filtration module according to claim 1, a filtration vessel that houses the filtration module, and an air bubble supply unit that supplies air bubbles from below the filtration module.
